(19) United States
(12) Patent Application Publication
(10) Pub. No.: US 2026/0099134 A1
(43) Pub. Date: Apr. 9, 2026

(54) DYNAMIC WIREFRAME PRINT-SUPPORT STRUCTURES

(71) Applicant: INTERNATIONAL BUSINESS MACHINES CORPORATION, Armonk, NY (US)

(72) Inventors: Tushar Agrawal, West Fargo (ND); Sarbajit Kumar Rakshit, Kolkata (IN); Carolina Garcia Delgado, Zapopan (MX); Aaron Keith Baughman, Cary, NC (US)

(21) Appl. No.: 18/908,161

(22) Filed: Oct. 7, 2024

(51) Int. Cl. G05B 19/4099

(52) U.S. Cl. CPC G05B 19/4099; G05B 2219/49023

(57) ABSTRACT

Methods and systems include creating a wireframe design based on a three-dimensional (3D) design for an object to provide structure for printing the object. A wireframe is assembled in accordance with the wireframe design. The object is printed using the wireframe design as support for printed material. The wireframe is disassembled.

### BACKGROUND

The present invention generally relates to additive manufacturing and, more particularly, to support structures for additive manufacturing processes.

Additive manufacturing processes, such as three-dimensional (3D) printing, make it possible to rapidly prototype and fabricate new structures. However, such additive manufacturing processes may have limitations that make it difficult to form certain types of objects. For example, a 3D structure that has a thin wall, or a wall that is sparsely filled, may sag during the printing process due to a lack of lateral support.

### SUMMARY

A method includes creating a wireframe design based on a three-dimensional (3D) design for an object to provide structure for printing the object. A wireframe is assembled in accordance with the wireframe design. The object is printed using the wireframe design as support for printed material. The wireframe is disassembled.

A computer program product includes one or more computer-readable storage media and program instructions stored on the one or more computer readable media. The program instructions perform operations that include creating a wireframe design based on a 3D design for an object to provide structure for printing the object, triggering assembly of a wireframe in accordance with the wireframe design, triggering printing of the object using the wireframe design as support for printed material, and triggering disassembly of the wireframe.

A computer system includes a processor set, one or more computer-readable storage media, and program instructions stored on the one or more computer readable media. The program instructions cause the processor set to perform operations that include creating a wireframe design based on a 3D design for an object to provide structure for printing the object, triggering assembly of a wireframe in accordance with the wireframe design, triggering printing of the object using the wireframe design as support for printed material, and triggering disassembly of the wireframe.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a three-dimensional (3D) printing system that uses a wireframe support, in accordance with an embodiment of the present invention;

FIG. 2 is a diagram of a support structure with integrated magnetic linking, in accordance with an embodiment of the present invention;

FIG. 3 is a block/flow diagram of a method of creating and using a wireframe support for 3D printing, in accordance with an embodiment of the present invention;

FIG. 4 is a block/flow diagram of a method for creating a wireframe design, in accordance with an embodiment of the present invention; and

FIG. 5 is a block diagram of a computing environment that can be used to perform wireframe design creation and assembly, in accordance with an embodiment of the present invention.

### DETAILED DESCRIPTION

Complex and fragile three-dimensional (3D) structures can be formed with additive manufacturing processes. However, some structures need support during the printing process to prevent them from sagging or collapsing. Temporary support structures can be designed and assembled to provide support that is tailored to the specific 3D design being formed. In particular, these temporary support structures may be formed with magnetic linking. Once the 3D object has finished printing, the support structures can be quickly and easily disassembled from within the object by applying a magnetic field that overwhelms the magnetic field strength of the magnetic links.

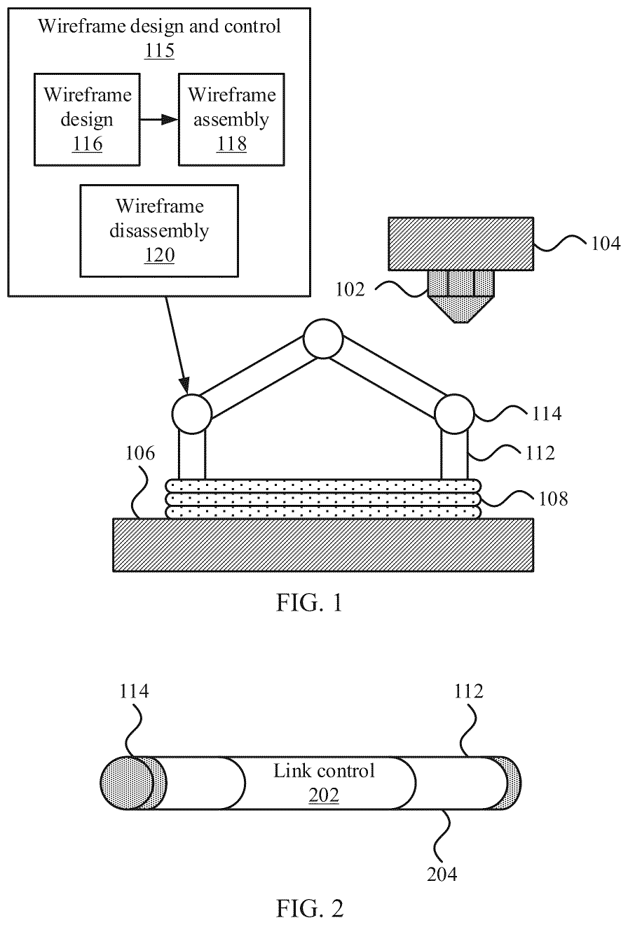

Referring now to FIG. 1, an exemplary 3D printing system is shown. A print head 102 is attached to a gantry 104 or other fixture that moves laterally over a print bed 106. As the print head moves, it extrudes a print material, which is deposited on the print bed 106. After a full layer is deposited, the gantry 104 moves the print head 102 vertically and a next layer is deposited on top of the previous layer. As multiple layers 108 are formed on top of one another, a 3D object is formed in accordance with an input design. In some embodiments, the layers 108 may be formed from polyethylene terephthalate glycol (PETG), a thermoplastic, but it should be understood that other materials may be used instead. This view of a 3D printing system is intended to be purely exemplary and should not be regarded as limiting—other types of 3D printing and additive manufacturing are contemplated and fall within the scope of the present principles.

The layers 108 may be formed from a filament material. As the filament material passes through the print head 102, it is heated to a temperature that causes it to adhere to the previous layers 108 or print bed 106. The layers 108 may be formed on or around support structures 112, which may be assembled before the 3D printing process begins to provide a wireframe support for the 3D object. The support structures 112 may be connected to one another by linking structures 114. It is specifically contemplated that the linking structures 114 may employ magnetic linking to hold adjacent support structures 112 together, but it should be understood that any appropriate alternative linking may be used instead.

The support structures 112 are assembled by wireframe design and control 115. Wireframe design 116 creates a design for a 3D wireframe support that is tailored to a 3D design of the object being printed. In particular, wireframe design 116 is tailored to provide structural support for portions of the 3D object that may be thin, unconnected to other parts of the 3D object, or otherwise weak or fragile. As will be described in greater detail below, the wireframe design 116 may be determined by an automatic process, such as a machine learning model. For example, if a wall of the 3D object is too thin to provide support for subsequent layers, then a wireframe structure may be designed to place a support structure 112 to provide physical support during the printing operation.

The wireframe assembly process 118 then assembles the support structures 112 according to the wireframe design 116. In some cases, wireframe assembly 118 may be automated using, e.g., a robotic placement system that positions the support structures 112 and causes them to link together using linking structures 114. After the 3D object has finished printing, wireframe disassembly 120 may be performed by applying a magnetic field that overwhelms the magnetic strength of the linking structures 114, causing the support structures to fall apart within the 3D object, where they can be easily removed. This magnetic field may be applied externally, for example using an electromagnetic installed around the printing surface. In some cases the wireframe disassembly 120 may be triggered during the 3D print, for example after a particular wall or structure of the 3D object has been formed, to make room for the addition of material in the space previously occupied by the support structures 112.

Referring now to FIG. 2, additional detail on the support structures 112 is shown. The support structures 112 may include a rod of any appropriately rigid material, such as a metal or plastic. In some cases, the linking structures 114 may be integrated with the ends of the support structures 112, for example including a natural magnet or electromagnet.

In some cases, when the linking structures 114 include electromagnets, they may be controlled by an internal link control 202, which may provide power and control circuitry. In such embodiments, the polarity of the linking structures 114 may be selected by, e.g., selecting a direction of current flow. The control circuitry may include wireless communication hardware, so that wireframe assembly 118 and wireframe disassembly 120 may communicate with the link control 202 to provide contactless operation of the support structures 112. In some cases, when the linking structures 114 are made with natural magnets, the link control 202 may be omitted.

A body 204 of the support structure 112 may be a rod having any appropriate length, cross-sectional shape, and cross-sectional size. The dimensions of the support structures 112 may be selected for the wireframe design 116 in accordance with the needs of the 3D object and the wireframe. For example, support structures 112 may be longer in areas where the 3D object will have larger flat surfaces, while shorter support structures 112 may be used in areas where the 3D object has a curved surface.

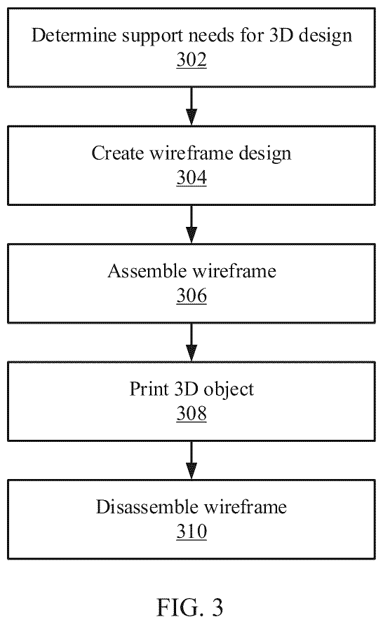

Referring now to FIG. 3, a 3D printing method is shown. Block 302 determines the support needs for a given 3D design. This analysis may include a consideration of the physical properties of the material being used to print the 3D design. For example, some materials may have a greater rigidity and need less physical support, while other materials may be relatively flexible. Based on this analysis, block 304 creates the wireframe design to provide the support that the 3D object needs during printing. The design selects type and position for a set of support structures 112, including their orientation with respect to one another to enable magnetic linking.

When creating the wireframe design, block 304 also accounts for disassembly, for example by determining movement vectors for each load-bearing point of the wireframe. These vectors identify how the wireframe will move when an external magnetic field is applied. If a selected set of points results in disassembly under the specified magnetic field, but causes one or more other points to fall into the wrong direction (e.g., up against the printed object) due to the polar nature of magnetic forces, then block 304 may add additional magnetic or insulating material to the load-bearing point to change the directional vector of that point.

In some cases, creation of the wireframe design may be performed using a graph model. The wireframe design may be treated as an optimization problem, similar to the knapsack packing problem, where the support needs of the 3D design are met by a minimal number of support structures 112. For example, each node in a graph may represent a linking structure 114, while the edges may represent the strength of the associated magnetic field. Nodes may be numbered according to their magnetic potential. A maximum flow problem can be solved to identify an amount of ferromagnetic material that can be added to the 3D object to lower the strength of the magnetic field through redirected of a selected edge of the graph, which can cause the nodes to shift. At each bin packing step, the resulting graph determines whether an objective has been reached.

In some cases, the wireframe design may be created by prompting a large language model (LLM) with the 3D design, or with a specification of the support needed by the 3D design, to create a wireframe structure output. The LLM is used to create a chain of reasoning around the selected potential solutions. The solutions are narrated by the LLM, with step-by-step assembly instructions for optional human review. The steps may be transformed by the LLM into a language of choice to provide instructions to drones, robots, or other machines to automatically build and disassemble the wireframe. The wireframe design may be split into any number of zones, with load bearing points being clustered into sections. The load bearing points of the wireframe are grouped together based on distance from one another and by directionality of the load.

Block 306 assembles the wireframe using the support structures 112, as dictated by the wireframe design. This may be performed manually, using an automatic robotic system, or some combination of the two. Block 308 prints the 3D object, using the wireframe to support the material as it is being deposited. The 3D object may be printed with ferromagnetic material, which can provide further magnetic connection to the wireframe and provide additional control on the magnetic forces that are exerted on the wireframe. Thus the creation of the wireframe design 304 may include modifications to the 3D printing design to control the use of magnetic and/or insulating material therein.

Block 310 then disassembles the wireframe, for example after the material of the 3D printing process has had time to solidify. Block 310 may perform the disassembly by applying a magnetic field that causes the linking structures 114 to unlink the support structures from one another. The disassembled support structures 112 may be collected and reused. In some cases the disassembly process may be augmented by human intervention, for example by visual inspection. If disassembly is incomplete, the visual inspection of the disassembly process can provide insights on how the wireframe design can be improved.

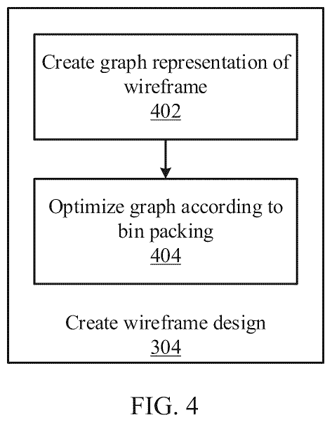

Referring now to FIG. 4, additional detail on the creation of the wireframe design 304 is shown. The creation of the wireframe design may include the creation of a graph representation of a wireframe 402, after which the graph may be optimized 404 to identify the types and positions of the support structures 112.

Block 402 may use a knapsack network flow topology approach to determine how and whether nodes within zones, or across zones, should be connected together in the wireframe. Each node may be a load bearing point, while the edges may represent the support structures 112. The edges may have values that represent the magnitude of a magnetic strength needed to disassemble that part of the wireframe. The node may further have a load bearing force number. The edges that connect the nodes together change and move to ensure the structure can handle natural load bearing forces and can collapse to a desirable location under an external magnetic field. A collapse simulation can be performed. Potential solutions may be identified as having a minimal number of magnetic rotation steps needed to disassemble the wireframe.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

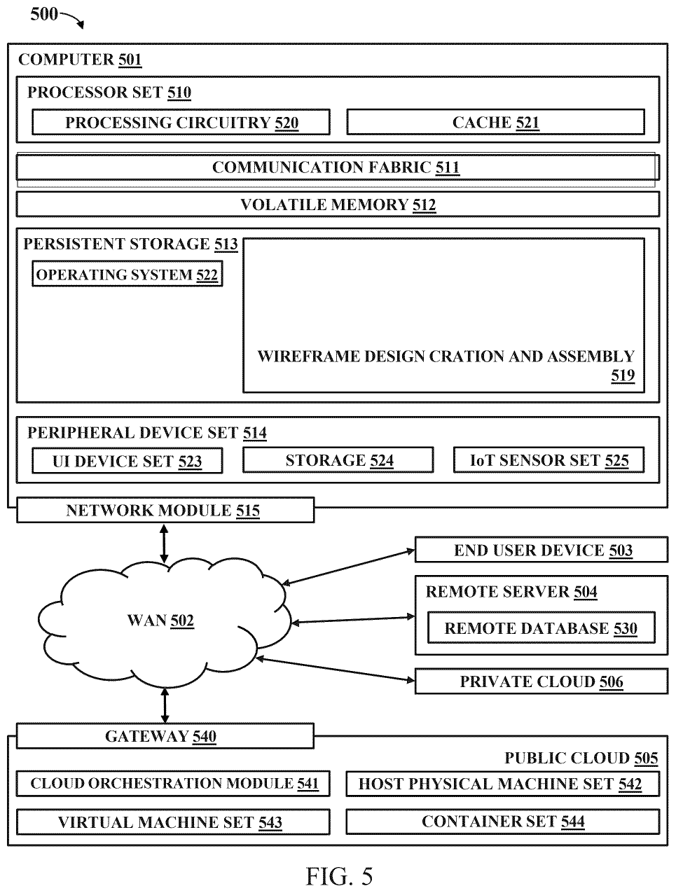

Referring now to FIG. 5, computing environment 500 contains an example of an environment for the execution of at least some of the computer code involved in performing the inventive methods, such as wireframe design creation and assembly 519. In addition to block 519, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 519, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip. ” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 519 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 519 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502.

Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of dynamic wireframe print support structures (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
creating a wireframe design based on a three-dimensional (3D) design for an object to provide structure for printing the object;
assembling a wireframe in accordance with the wireframe design;
printing the object using the wireframe design as support for printed material; and
disassembling the wireframe.

2. The method of claim 1, wherein assembling the wireframe includes linking a plurality of support structures together magnetically.

3. The method of claim 2, wherein disassembling the wireframe includes applying an external magnetic field that disconnects the magnetically linked support structures.

4. The method of claim 2, wherein creating the wireframe design includes selecting lengths of the support structures.

5. The method of claim 2, wherein assembling the wireframe includes linking the plurality of support structures together using a robotic placement system.

6. The method of claim 2, wherein the support structures include rigid rods with a magnetic linking structure.

7. The method of claim 6, wherein the magnetic linking structures are selected from the group consisting of natural magnets and electromagnets.

8. The method of claim 1, wherein creating the wireframe design includes prompting a large language model with the 3D design for the object to generate the wireframe design.

9. The method of claim 1, wherein creating the wireframe design includes optimizing a wireframe graph using a bin packing approach.

10. A computer program product, comprising:
one or more computer-readable storage media; and
program instructions stored on the one or more computer readable storage media to perform operations comprising:
creating a wireframe design based on a three-dimensional (3D) design for an object to provide structure for printing the object;
triggering assembly of a wireframe in accordance with the wireframe design;
triggering printing of the object using the wireframe design as support for printed material; and
triggering disassembly of the wireframe.

11. A computer system, comprising:
a processor set;
one or more computer-readable storage media; and
program instructions stored on the one or more computer readable storage media to cause the processor set to perform operations comprising:
creating a wireframe design based on a three-dimensional (3D) design for an object to provide structure for printing the object;
triggering assembly of a wireframe in accordance with the wireframe design;
triggering printing of the object using the wireframe design as support for printed material; and
triggering disassembly of the wireframe.

12. The system of claim 11, wherein the assembly includes linking a plurality of support structures together magnetically.

13. The system of claim 12, wherein the disassembly includes applying an external magnetic field that disconnects the magnetically linked support structures.

14. The system of claim 12, wherein creating the wireframe design includes selecting lengths of the support structures.

15. The system of claim 12, wherein the assembly includes linking the plurality of support structures together using a robotic placement system.

16. The system of claim 12, wherein the support structures include rigid rods with a magnetic linking structure.

17. The system of claim 16, wherein the magnetic linking structures are selected from the group consisting of natural magnets and electromagnets.

18. The system of claim 11, wherein creating the wireframe design includes prompting a large language model with the 3D design for the object to generate the wireframe design.

19. The system of claim 11, wherein creating the wireframe design includes optimizing a wireframe graph using a bin packing approach.

20. The system of claim 11, further comprising an electromagnet that applies a magnetic field when triggered to disassemble the wireframe.
